(19) United States
(12) Patent Application Publication
(10) Pub. No.: US 2006/0037010 A1
(43) Pub. Date: Feb. 16, 2006

(54) Processor arrangement and method for operation thereof

(76) Inventor: Philip Graham Willoughby, Romsey (GB)

Correspondence Address: IBM CORPORATION;INTELLECTUAL PROPERTY LAW, 11400 BURNET ROAD, AUSTIN, TX, 78758, US

(21) Appl. No.: 11/201,655

(22) Filed: Aug. 11, 2005

(30) Foreign Application Priority Data
Aug. 12, 2004 (GB) 0417970.1

(51) Int. Cl. G06F 9/45

(52) U.S. Cl. 717/151

(57) ABSTRACT

A method and arrangement (100) for remapping of registers (130₀-130₁₇) of a processor (130) to improve runtime performance of dynamically linked applications or to simplify the code for a wide class of iterative refinement algorithms is based on providing a CPU instruction to remap registers en masse. The advantage of this is that it is simpler and faster than recompiling things at runtime and it obviates use of a calling convention, so that the parameter ordering in registers is the same for all calls regardless of what the optimum layout might be, allowing more efficient code. Compilers would also be simpler to write and test, and code would compile far quicker than it does at present, since it would eliminate many previous constraints on register allocation, making optimisation far simpler.

### FIELD OF THE INVENTION

This invention relates to the running of software on processors.

### BACKGROUND OF THE INVENTION

When software is written, the writer typically likes to split it into separate modules at the design stage. It is preferred to keep these modules separate throughout the software product lifecycle, because that allows the writer to repair or improve each component separately without the need to replace the entire product. These components are commonly shipped as shared libraries, also known as Dynamic Linked Libraries (DLLs).

It is known it can be problematic to optimise code which uses shared libraries. If a code compiler has access to the source for all the routines used in a program when it compiles the code, it can take steps to eliminate the cost of calling them. One of the major speed-ups which can be achieved is to align the callee's expectation of the location of parameters in processor registers with the locations the caller already has for them. In a dynamically linked environment this is impossible, and a calling convention must be used, so that the parameter ordering in registers is the same for all calls regardless of what the optimum layout might be.

Thus, this approach has the disadvantages that use of a calling convention is required, so that the parameter ordering in registers is the same for all calls regardless of what the optimum layout might be, which may result in inefficient code.

Although just-in-time compilation might be used to solve this problem for interpreted languages, the complexity of required cross-call register optimisation would make such an approach unattractive.

A need therefore exists for a method and arrangement for wherein the abovementioned disadvantage(s) may be alleviated.

### STATEMENT OF INVENTION

In accordance with a first aspect of the present invention there is provided a processor arrangement comprising a processor having a plurality of registers and having a plurality of instructions for processing data, the plurality of registers having a predetermined mapping, and the processor additionally having an instruction for re-mapping the plurality of registers.

In accordance with a second aspect of the present invention there is provided method of operating a processor arrangement comprising a processor having a plurality of registers and having a plurality of instructions for processing data, the plurality of registers having a predetermined mapping, the method comprising calling an instruction from the plurality of instructions for re-mapping the plurality of registers.

Briefly stated, at least in a preferred embodiment the present invention is based on providing a CPU instruction to remap registers en masse. The advantage of this is that it is simpler and faster than recompiling things at runtime. Compilers would also be simpler to write and test, and code would compile far quicker than it does at present, since it would eliminate many previous constraints on register allocation, making optimisation far simpler.

### BRIEF DESCRIPTION OF THE DRAWING(S)

Two schemes for register remapping to improve runtime performance of dynamically linked applications incorporating the present invention will now be described, by way of example only, with reference to the accompanying drawings, in which:

FIG. 1 is a block schematic diagram showing a computer system including a computer program, compiler and processor incorporating the present invention;

FIG. 2A, 2B & 2C are block schematic diagrams showing different stages of register re-mapping in the system of FIG. 1.

### DESCRIPTION OF PREFERRED EMBODIMENT(S)

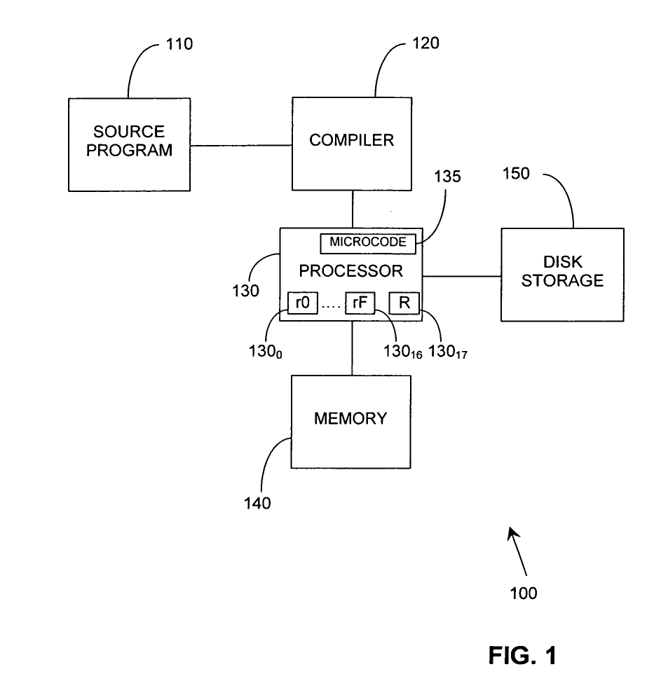

Referring firstly to FIG. 1, a computer system 100 in which the invention is used includes a source computer program 110, a compiler 120 and a central processing unit (CPU) processor 130 with associated memory 140 and disk storage 150. The processor 130 has a range of registers 130₀-130₁₆ and 130₁₇.

As mentioned above, the system 100 is provided, in its microcode 135, with a CPU instruction to remap registers en masse. The advantage of this is that it is simpler and faster than recompiling things at runtime. Compilers can be simpler to write and test, and code can compile far quicker than previously, since many of the previous constraints on register allocation are eliminated, making the optimisation stage far simpler.

To make this work, the normal-linking system needs to be extended slightly. Conventionally, the compiler places indirect references to routines in the program it builds, along with a symbol table which maps names to the addresses which must be filled in (relative to the appropriate segment). This is a trivial operation, and is the same process for all linking, so global variables are linked in this way also.

To take advantage of the new instruction, the linker needs to be altered to treat variables and calls differently. For calls, the linker needs to compute the register translation to match up the two ends of the call, and fill this into the code before the call to the function. It also needs to reverse the mapping after the call. These steps are not taken for variables, of course. This would obviously also imply some changes to the compiler—it needs to leave sufficient space in the code for the linker to fill in all these instructions rather than just enough space for the address.

The following is an example of some assembler pseudo-code in AT&T® style for an Intel®-like processor (second operand is second source register and destination register for 2-operand instructions), assuming a machine with 16 64-bit general purpose registers, showing the conventional method of reordering 5 registers (r0-r4) for a function call:
; Mapping we wish to achieve:
; r0->r4
; r1->r2
; r2->r3
; r3->r1
; r4->r0
; First swap r0 and r4
xor r4, r0
xor r0, r4
xor r4, r0
; now we need to cycle r1->r2->r3 (and r3->r1)
xor r1, r2
xor r1, r3
xor r3, r1
xor r2, r3
xor r1, r3
xor r3, r2
   And here is how it looks with a new remap instruction:
; First we load the mapping code into a spare register, R
load 0x4231056789ABCDEF, R
; now we call remap
remap R

Clearly, the second code example is a much cleaner. The above example assumed that the minimum modification was made to the assembler—however it the assembler were extended to understand how to load remap instructions, perhaps with a pseudo-instruction of loadremap, it would look like this:
; First we load the mapping code into a spare register, R
loadremap
(r4,r2,r3,r1,r0,r5,r6,r7,r8,r9,rA,rB,rC,rD,rE,rF),R
; now we call remap
remap R

Clearly, the loadremap and remap procedure is many times more understandable than the first example.

It will be appreciated that the register used as parameter to the remap instruction may be either an existing general-purpose register, or a register added to the processor for the purpose of allowing remapping.

It is more complex to apply this technique to routines located through a vector table, since the mapping could change at runtime. However, in most cases, it will be possible to take advantage of instruction ordering and prefetching to determine a suitable mapping before needing to make the call. The following is an example of how this could be taken advantage of:
; method takes 5 parameters, currently in r6,r8,rA,rB,r3
; first, load the mapping code to match the calling convention into a spare register, R
loadremap
(r6,r8,rA,rB,r3,r5,r0,r7,r1,r9,r2,r4,rC,rD,rE,rF),R
; Perform the remapping
remap rFR

In this case the remap instruction is used to put the parameters into registers according to a calling convention, the called routine can then call remap again as necessary to get the data into the registers it needs. This leads neatly to a method of encoding the necessary mappings and by coincidence enabling backwards compatibility and ‘vtable’ lookups with little effort.

The caller has a remap function to meet the calling convention just before the call, and the callee has a remap instruction to move from the convention to its preferred locations as its first instruction. This means that legacy code can call routines that use the remap instructions, since the convention need not change and thus the caller need not know. Also remap-using applications could call legacy library routines for the same reason. However, a smart linker could unify the two consecutive remaps and jump into the called function one instruction later for a performance boost.

In terms of implementation, there are a number of options for now and for the future. For now, this remap scheme can be implemented with a lookup table (e.g., in memory 140) and a microcode update (e.g., to microcode 135) on most processors. The lookup table would necessarily need to occupy some part of the processor's in-core memory, or it would not be sufficiently rapid (the latency of a main-memory round-trip would be so high as to render this useless). The lookup table could have one entry per software-perceived register, and this entry would identify the hardware register in which the data for that software-level register currently resides.

In the medium term, it might be possible to use Field Programmable Gate Array (FPGA) technology to physically rewire the chip. Although the speed of reprogramming FPGAs may limit use of current FPGAs for this purpose, it is to be expected that future FPGAs will be able to be reprogrammed rapidly enough to allow use in this way. It will be appreciated that this would allow register remapping using an FPGA on a processor which does not have microcode.

In a second preferred embodiment, there is provided an instruction to permute the registers of a processor in an arbitrary way. The syntax suggest for the use of this instruction in assembler is:
preg <new register order>
   For instance, on a machine with 16 registers (r0-rF), this would be a no-op:
preg r0,r1,r2,r3,r4,r5,r6,r7,r8,r9,rA,rB,rC,rD,rE,rF

This would be useful for many things, but the main benefit would be to improve the possibilities for load-time link optimisation.

Currently, the assembler dump for a function call tends to be something like the following (the 4 values to be passed start in r1, rC, r0 and r9 respectively):
xor r1, r0; This and the 2 following lines swap the values in r1 and r0
xor r0, r1
xor r1, r0
xor rC, r1; This and the 2 following lines swap the values in rC and r1
xor r1, rC
xor rC, r1
xor rC, r2; This and the 2 following lines swap the values in rC and r2
xor r2, rC
xor rC, r2
xor r9, r3; This and the 2 following lines swap the values in r9 and r3
xor r3, r9
xor r9, r3
.call dostuff

This is a lot of code to accomplish something so simple. Current software development techniques favour factoring a program into as many distinct functions as possible to aid maintenance. This means that the machine-level cost of a function call is beginning to seem significant.

An optimising compiler will take steps to ensure that the values are in the right registers ahead of time, scheduling the register swaps so that they take place while another execution unit is being used. However, the moves must still take place, and will still take some cycles away from real work. Further, the optimiser will spend most of its time doing this—if it didn't have to it could execute more rapidly, or use the time for other optimisations.

It would be better if the load-time linker did the work of matching the caller and callee register layouts. To accomplish this, enough space needs to be left in the caller's code stream to allow the runtime linker to permute the registers appropriately. However, to do this with current technology requires that enough space is left for 3 XOR instructions per parameter. This would reduce the efficiency of the processor instruction cache, and make the runtime linker quite complex. On a system with the preg instruction, however, things would be much simpler: one would simply leave space for a single preg instruction.

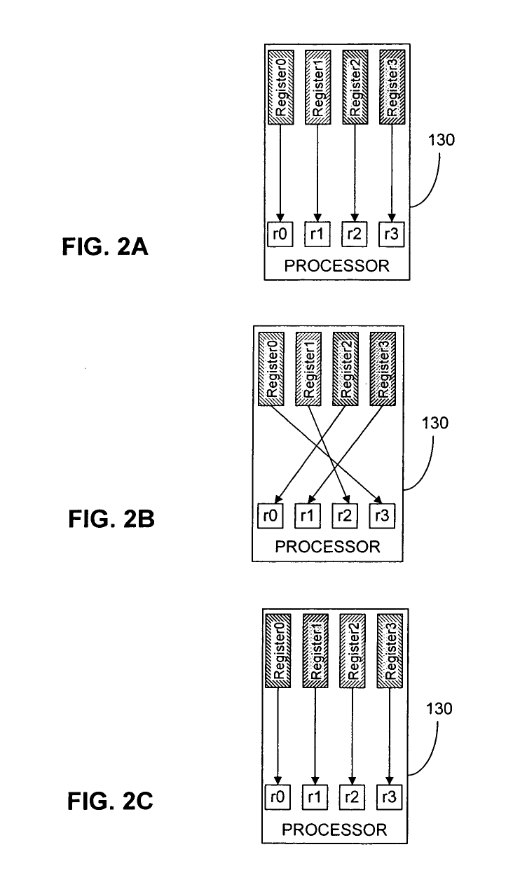

FIGS. 2A, 2B & 2C show different stages of register re-mapping using the preg instruction. In FIGS. 2A, 2B & 2C the shading of the registers represents the data contained therein, and the names of the registers r0-r3 indicate that from a software point of view the registers do not really move. FIG. 2A shows the initial layout of the registers as perceived by software. FIG. 2B shows the result of the first stage of a preg operation (preg r2, r3, r1, r0). The registers have been effectively rewired so that Register2 is connected to r0, Register3 to r1, Register1 to r2 and Register0 to r3. FIG. 2C shows the result of the second stage of the preg operation. The rewired registers have been renamed so that Register0 is connected to r0, Register1 to r1 and so on. At this stage the preg call which began above is now complete. It may be noted that it does not matter if the registers are rewired and renamed or just have their contents swapped around.

The change to preg can be made gradually, without disruption to existing software, because:
The old link style would still be available;
New-style programs could be linked to old-style libraries (trivially the runtime linker would put a translation to the old calling-convention register layout into the preg space in the caller);
Old-style programs linking to new-style libraries could be supported, simply by making the instruction before the new entry-point an appropriate translation from the old calling convention to the new, and linking the old programs to that address.

However, new-style programs and libraries would fail on hardware which did not support preg.

It will be appreciated that there are other uses to which a register permutation instruction could be put—it would simplify the code for a wide class of iterative refinement algorithms.

It will be appreciated that the software code using the remap or preg instructions described above will typically be provided as a computer program element carried on any suitable data carrier (not shown) such as a magnetic or optical computer disc.

It will also be appreciated that as an alternative to the register mapping implementations in the preferred embodiments described above, register mapping may also be performed by swapping the contents of the registers for which remapping has been requested.

It will be understood that the method and arrangement for register remapping to improve runtime performance of dynamically linked applications or to simplify the code for a wide class of iterative refinement algorithms described above provides the advantages of obviating use of a calling convention, so that the parameter ordering in registers is the same for all calls regardless of what the optimum layout might be, allowing more efficient code.

What is claimed is:

1. A processor arrangement comprising:
a processor having a plurality of registers and having a plurality of instructions for processing data, the plurality of registers having a predetermined mapping, and
the processor additionally having an instruction for re-mapping the plurality of registers.

2. The processor arrangement of claim 1 wherein the instruction for re-mapping the plurality of registers is comprised in microcode.

3. The processor arrangement of claim 1 wherein the instruction for re-mapping the plurality of registers is arranged to use a memory look-up table.

4. The processor arrangement of claim 1 wherein the instruction for re-mapping the plurality of registers is arranged to use a Field Programmable Gate Array.

5. A method of operating a processor arrangement comprising a processor having a plurality of registers and having a plurality of instructions for processing data, the plurality of registers having a predetermined mapping,
the method comprising calling an instruction from the plurality of instructions for re-mapping the plurality of registers.

6. The method of claim 5 wherein the instruction for re-mapping the plurality of registers is comprised in microcode.

7. The method of claim 5 wherein the step of calling the instruction for re-mapping the plurality of registers comprises using a memory look-up table.

8. The method of claim 5 wherein the step of calling the instruction for re-mapping the plurality of registers comprises using a Field Programmable Gate Array.

9. The method of claim 5 comprising:
a first step of calling the instruction for re-mapping the plurality of registers in caller code to meet a predetermined calling convention, and
a second step of calling the instruction for re-mapping the plurality of registers in called code to move from the predetermined calling convention.

10. A computer program element comprising computer program means for performing substantially the method of claim 5.
